(19) United States
(12) Patent Application Publication
(10) Pub. No.: US 2016/0080733 A1
(43) Pub. Date: Mar. 17, 2016

(54) SHUTTER GLASSES, METHOD FOR DRIVING THE SHUTTER GLASSES, AND DISPLAY DEVICE USING THE SAME

(71) Applicant: SAMSUNG DISPLAY CO., LTD., Yongin-City (KR)

(72) Inventors: Ji Hoon Kim, Seoul (KR); Gyu Hyeon Kim, Suwon-si (KR); Hyeon Jin Kim, Tongyeong-si (KR); Se Huhn Hur, Yongin-si (KR)

(21) Appl. No.: 14/633,055

(22) Filed: Feb. 26, 2015

(30) Foreign Application Priority Data
Sep. 12, 2014 (KR) 10-2014-0121210

(51) Int. Cl. H04N 13/04

(52) U.S. Cl. CPC H04N 13/0438; H04N 13/0497; H04N 13/0484

(57) ABSTRACT

Shutter glasses in accordance with an exemplary embodiment of the present invention include a shutter lens configured to transmit an image of a display unit and a controller configured to control shutoff of the shutter lens. The shutter lens includes a first shutter block and a second shutter block, and the controller controls shutoff of the first shutter block in response to an image of the first display block of the display unit and controls shutoff of the second shutter block in response to an image of the second display block of the display unit.

### CROSS-REFERENCE TO RELATED APPLICATION

This application claims priority to and the benefit of Korean Patent Application No. 10-2014-0121210, filed in the Korean Intellectual Property Office, on Sep. 12, 2014, the entire content of which is incorporated herein by reference.

### BACKGROUND

1. Field

The following description relates to shutter glasses for displaying a stereoscopic image, operations of the shutter glasses for displaying a stereoscopic image, and a display device for displaying a stereoscopic image.

2. Description of the Related Art

In general, a stereoscopic image display device implements a three-dimensional effect in a 2D image using the principle that disparity between both eyes is increased when an object is close to a user and disparity between both eyes is reduced when an object is far from a user. For example, if left and right images are matched and displayed on a screen, an object is perceived as being placed on the screen. If a left eye image is disposed on the left and a right eye image is disposed on the right, an object is perceived as being placed behind a screen. If a left eye image is disposed on the right and a right eye image is disposed on the left, an object is perceived as being placed ahead of a screen. In this case, a feeling of depth of the object is determined by the distance between the left and right images disposed on the screen.

In a related art time-division stereoscopic image display method, a Black Frame Insertion (BFI) operation, a Back Light Unit (BLU) control operation, or a high-speed frame rate operation are used in order to improve image cross-talk attributable to the limit of a liquid crystal response speed and a driving characteristic inherent in an LCD. However, such an operation is problematic in that power consumption is increased, an LED is degraded, and the unit cost of goods rises due to increased BLU driving circuits.

The above information disclosed in this Background section is only for enhancement of understanding of the background of the invention and therefore it may contain information that does not form the prior art that is already known in this country to a person of ordinary skill in the art.

### SUMMARY

An aspect of an embodiment of the present invention is directed toward shutter glasses for displaying a stereoscopic image, which are capable of improving image cross-talk and also being driven at a low speed.

Technical aspects to be achieved by the present invention are not limited to the aforementioned aspect, and other technical aspects that have not been described will be evidently understood by those skilled in the art from the following description.

Shutter glasses in accordance with an exemplary embodiment of the present invention include a shutter lens configured to transmit an image of a display unit and a controller configured to control shutoff of the shutter lens, wherein the shutter lens includes a first shutter block and a second shutter block, and wherein the controller controls shutoff of the first shutter block in response to an image of the first display block of the display unit and controls shutoff of the second shutter block in response to an image of the second display block of the display unit.

Furthermore, in accordance with an exemplary embodiment of the present invention, the display unit of the shutter glasses alternately displays a left eye image and a right eye image, the shutter lens includes a left eye shutter lens and a right eye shutter lens, and the controller controls the shutoff of the left eye shutter lens in response to the left eye image and controls the shutoff of the right eye shutter lens in response to the right eye image.

The shutter glasses in accordance with an exemplary embodiment of the present invention further include a measurement unit configured to measure user location information. The user location information includes the distance between a pupil of a user and the display unit, an actual viewing range according to the distance, a first angle from the pupil to the lowest viewpoint of the first display block, a second angle from the pupil to the highest viewpoint of the display unit, and a third angle from the pupil to the highest viewpoint of the actual viewing range. The controller controls points of time of the shutoff of the first shutter block and the second shutter block based on the user location information.

In accordance with an exemplary embodiment of the present invention, the actual viewing range of the shutter glasses includes a first viewing range block, and the controller calculates the length of the first viewing range block utilizing the first angle and the second angle and controls the first shutter block utilizing the length of the first viewing range block so that the first shutter block is open at a first point of time.

In accordance with an exemplary embodiment of the present invention, the controller of the shutter glasses calculates the length of the first viewing range block utilizing the first angle and the third angle.

In accordance with an exemplary embodiment of the present invention, the lowest viewpoint of the first display block of the shutter glasses is identical with the highest viewpoint of the display unit.

In accordance with an exemplary embodiment of the present invention, the actual viewing range of the shutter glasses includes a second viewing range block. The user location information includes a fourth angle from the pupil to the lowest viewpoint of the second viewing range block, a fifth angle from the pupil to the highest viewpoint of the display unit, and a sixth angle from the pupil to the highest viewpoint of the second viewing range block. The controller calculates the length of the second viewing range block utilizing the fifth angle and the sixth angle, calculates a delay length utilizing the fourth angle and the fifth angle, calculates a second point of time utilizing the length of the second viewing range block and the delay length, and controls the first shutter block so that the first shutter block is open at the second point of time.

In accordance with an exemplary embodiment of the present invention, the second point of time of the shutter glasses is earlier than the first point of time.

In accordance with an exemplary embodiment of the present invention, the highest viewpoint of the display unit of the shutter glasses is higher than the highest viewpoint of the actual viewing range.

In accordance with an exemplary embodiment of the present invention, the actual viewing range of the shutter glasses includes a third viewing range block. The user location information includes a seventh angle from the pupil to the lowest point of the third viewing range block, an eighth angle from the pupil to the highest viewpoint of the display unit, and a ninth angle from the pupil to the highest viewpoint of the third viewing range block. The controller calculates the length of the third viewing range block utilizing the seventh angle and the eighth angle, calculates a preceding length utilizing the seventh angle and the ninth angle, calculates a corresponding third point of time utilizing the length of the third viewing range block and the preceding length, and controls the first shutter block so that the first shutter block is open at the third point of time.

In accordance with an exemplary embodiment of the present invention, the third point of time of the shutter glasses is later than the first point of time.

In accordance with an exemplary embodiment of the present invention, the highest viewpoint of the display unit of the shutter glasses is lower than the highest viewpoint of the actual viewing range.

In accordance with an exemplary embodiment of the present invention, a method of driving shutter glasses including a shutter lens configured to include a first shutter block and a second shutter block, a measurement unit configured to measure user location information, and a controller configured to control shutoff of the shutter lens includes measuring user location information and controlling shutoff of the first shutter block in response to an image of the first display block of a display unit, and controlling shutoff of the second shutter block in response to an image of the second display block of the display unit.

In the method of driving the shutter glasses in accordance with an exemplary embodiment of the present invention, the display unit alternately displays a left eye image and a right eye image, the shutter lens includes a left eye shutter lens and a right eye shutter lens, and the controller controls shutoff of the left eye shutter lens in response to the left eye image and controls shutoff of the right eye shutter lens in response to the right eye image.

In the method of driving the shutter glasses in accordance with an exemplary embodiment of the present invention, the measuring of the user location information includes measuring the distance between the pupil of a user and the display unit, and measuring an actual viewing range according to the distance, a first angle from the pupil to the lowest viewpoint of the first display block, a second angle from the pupil to the highest viewpoint of the display unit, and a third angle from the pupil to the highest viewpoint of the actual viewing range. The controlling of the shutoff includes controlling a point of time of the shutoff of the first shutter block and second shutter block based on the user location information.

In the method of driving the shutter glasses in accordance with an exemplary embodiment of the present invention, the actual viewing range includes a first viewing range block. The controlling of the point of time of the shutoff of the first shutter block includes calculating the length of the first viewing range block utilizing the first angle and the second angle, calculating a first point of time utilizing the length of the first viewing range block, and driving the first shutter block so that the first shutter block is open at the first point of time.

In the method of driving the shutter glasses in accordance with an exemplary embodiment of the present invention, the lowest viewpoint of the first display block is identical with the highest viewpoint of the display unit.

In the method of driving the shutter glasses in accordance with an exemplary embodiment of the present invention, the actual viewing range includes a second viewing range block. The user location information includes a fourth angle from the pupil to the lowest viewpoint of the second viewing range block, a fifth angle from the pupil to the highest viewpoint of the display unit, and a sixth angle from the pupil to the highest viewpoint of the second viewing range block. The controlling of the point of time of the shutoff of the first shutter block includes calculating the length of the second viewing range block utilizing the fifth angle and the sixth angle, calculating a delay length utilizing the fourth angle and the fifth angle, calculating a corresponding second point of time utilizing the length of the second viewing range block and the delay length, and driving the first shutter block so that the first shutter block is open at the second point of time.

In the method of driving the shutter glasses in accordance with an exemplary embodiment of the present invention, the second point of time is earlier than the first point of time.

In the method of driving the shutter glasses in accordance with an exemplary embodiment of the present invention, the highest viewpoint of the display unit is higher than the highest viewpoint of the actual viewing range.

In the method of driving the shutter glasses in accordance with an exemplary embodiment of the present invention, the actual viewing range includes a third viewing range block. The user location information includes a seventh angle from the pupil to the lowest viewpoint of the third viewing range block, an eighth angle from the pupil to the highest viewpoint of the display unit, and a ninth angle from the pupil to the highest viewpoint of the third viewing range block. The controlling of the point of time of the shutoff of the first shutter block includes calculating the length of the third viewing range block utilizing the seventh angle and the eighth angle, calculating a preceding length utilizing the seventh angle and the ninth angle, calculating a third point of time utilizing the length of the third viewing range block and the preceding length, and driving the first shutter block so that the first shutter block is open at the third point of time.

In the method of driving the shutter glasses in accordance with an exemplary embodiment of the present invention, the third point of time is later than the first point of time.

In the method of driving the shutter glasses in accordance with an exemplary embodiment of the present invention, the highest viewpoint of the display unit is lower than the highest viewpoint of the actual viewing range.

In a display device including a display unit and shutter glasses in accordance with an exemplary embodiment of the present invention, shutter glasses include a shutter lens configured to transmit an image of the display unit and a controller configured to control shutoff of the shutter lens, wherein the shutter lens includes a first shutter block and a second shutter block, the controller controls shutoff of the first shutter block in response to an image of the first display block of the display unit, and controls shutoff of the second shutter block in response to an image of the second display block of the display unit.

In the display device in accordance with an exemplary embodiment of the present invention, the display unit alternately displays a left eye image and a right eye image, the shutter lens includes a left eye shutter lens and a right eye shutter lens, and the controller controls shutoff of the left eye shutter lens in response to the left eye image and controls shutoff of the right eye shutter lens in response to the right eye image.

In the display device in accordance with an exemplary embodiment of the present invention, the shutter glasses further include a measurement unit configured to measure user location information. The user location information includes the distance between the pupil of a user and the display unit, an actual viewing range according to the distance, a first angle from the pupil to the lowest viewpoint of the first display block, a second angle from the pupil to the highest viewpoint of the display unit, and a third angle from the pupil to the highest viewpoint of the actual viewing range. The controller controls points of time of the shutoff of the first shutter block and the second shutter block based on the user location information.

In the display device in accordance with an exemplary embodiment of the present invention, the actual viewing range includes a first viewing range block, and the controller calculates the length of the first viewing range block utilizing the first angle and the second angle and controls the first shutter block utilizing the length of the first viewing range block so that the first shutter block is open at a first point of time.

In the display device in accordance with an exemplary embodiment of the present invention, the controller calculates the length of the first viewing range block utilizing the first angle and the third angle.

In the display device in accordance with an exemplary embodiment of the present invention, the lowest viewpoint of the first display block is identical with the highest viewpoint of the display unit.

In accordance with an exemplary embodiment of the present invention, the actual viewing range of the display device includes a second viewing range block. The user location information includes a fourth angle from the pupil to the lowest viewpoint of the second viewing range block, a fifth angle from the pupil to the highest viewpoint of the display unit, and a sixth angle from the pupil to the highest viewpoint of the second viewing range block. The controller calculates the length of the second viewing range block utilizing the fifth angle and the sixth angle, calculates a delay length utilizing the fourth angle and the fifth angle, calculates a second point of time utilizing the length of the second viewing range block and the delay length, and controls the first shutter block so that the first shutter block is open at the second point of time.

In the display device in accordance with an exemplary embodiment of the present invention, the second point of time of the display device is earlier than the first point of time.

In the display device in accordance with an exemplary embodiment of the present invention, the highest viewpoint of the display unit of the display device is higher than the highest viewpoint of the actual viewing range.

In the display device in accordance with an exemplary embodiment of the present invention, the actual viewing range includes a third viewing range block. The user location information includes a seventh angle from the pupil to the lowest viewpoint of the third viewing range block, an eighth angle from the pupil to the highest viewpoint of the display unit, and a ninth angle from the pupil to the highest viewpoint of the third viewing range block. The controller calculates the length of the third viewing range block utilizing the seventh angle and the eighth angle, calculates a preceding length utilizing the seventh angle and the ninth angle, calculates a corresponding third point of time utilizing the length of the third viewing range block and the preceding length, and controls the first shutter block so that the first shutter block is open at the third point of time.

In the display device in accordance with an exemplary embodiment of the present invention, the third point of time is later than the first point of time.

In the display device in accordance with an exemplary embodiment of the present invention, the highest viewpoint of the display unit is lower than the highest viewpoint of the actual viewing range.

In accordance with an exemplary embodiment of the present invention, the shutter glasses, an operation of the shutter glasses, and the display device using the same are advantageous in that power consumption can be reduced.

Furthermore with an exemplary embodiment of the present invention, there is an advantage in that a stereoscopic image having improved image cross-talk can be displayed even with low-speed driving.

In addition with an exemplary embodiment of the present invention, there is an advantage in that a stereoscopic image having an improved representation of a residual image attributable to the degradation of a display panel can be displayed.

### BRIEF DESCRIPTION OF THE DRAWINGS

FIG. 1 is a diagram illustrating a display system in accordance with an exemplary embodiment of the present invention;

FIG. 2 is a diagram schematically illustrating an operation of the display system in accordance with an exemplary embodiment of the present invention;

FIG. 3 is a block diagram of the display system in accordance with an exemplary embodiment of the present invention;

FIG. 4 is a block diagram of shutter glasses in accordance with an exemplary embodiment of the present invention;

FIG. 5 is a diagram illustrating a left eye shutter in accordance with an exemplary embodiment of the present invention;

FIG. 6 is a diagram illustrating a display unit in accordance with an exemplary embodiment of the present invention;

FIG. 7 is a diagram illustrating driving timing of the shutter glasses in accordance with an exemplary embodiment of the present invention;

FIG. 8 provides diagrams illustrating an operation of the shutter glasses in accordance with an exemplary embodiment of the present invention;

FIG. 9 is a diagram illustrating upper and lower viewing angles of a user;

FIG. 10 is a diagram illustrating the operation of the shutter glasses when an actual viewing range is equal to the height of the display unit;

FIG. 11 is a diagram illustrating the operation of the shutter glasses when an actual viewing range is less than the height of the display unit;

FIG. 12 is a diagram illustrating the operation of the shutter glasses when an actual viewing range exceeds the height of the display unit;

FIG. 13 is a diagram illustrating an operation of the shutter glasses in accordance with another exemplary embodiment of the present invention; and

FIG. 14 is a flowchart illustrating an operation of the shutter glasses in accordance with an exemplary embodiment of the present invention.

### DETAILED DESCRIPTION

Hereinafter, exemplary embodiments disclosed in this specification are described in detail with reference to the accompanying drawings. The same or similar constituent elements are assigned the same or similar reference numerals, and redundant descriptions thereof are omitted. It is to be noted that the suffixes of constituent elements used in the following description, such as “module” and “unit,” are assigned or interchangeable with each other by taking into consideration only the ease of writing this specification, but in themselves are not particularly given distinct meanings and roles. Furthermore, in describing the exemplary embodiments disclosed in this specification, a detailed description of the known technologies will be omitted if it is deemed to make the gist of the present invention unnecessarily vague. In addition, it is to be understood that the accompanied drawings are intended to make the exemplary embodiments disclosed in this specification easily understood, that the technical spirit disclosed in this specification is not restricted by the accompanying drawings, and that the exemplary embodiments include all modifications, equivalents, and substitutions which fall within the spirit and technical scope of the present invention.

Terms including ordinal numbers, such as first and second, may be used to describe various constituent elements, but the constituent elements are not limited by the terms. The terms are only used to distinguish one constituent element from the other constituent element.

When it is said that one constituent element is “connected” or “coupled” with the other constituent element, it should be understood that one constituent element may be directly connected or coupled with the other constituent element, or one or more third elements may exist between the two constituent elements. In contrast, when it is said that one constituent element is “directly connected” or “directly coupled” with the other constituent element, it should be understood that a third constituent element does not exist between the two elements.

An expression of the singular number includes an expression of the plural number unless clearly defined otherwise in the context.

In this specification, expressions, such as “include”, “have”, or “comprise,” are intended to indicate the existence of a characteristic, number, act, operation, constituent element, or component or a combination of them in the specification, and should be understood to not exclude the existence of one or more other characteristics, numbers, acts, operations, elements, or components or a combination of them or a possibility of the addition of them. Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Further, the use of “may” when describing embodiments of the inventive concept refers to “one or more embodiments of the inventive concept.” Also, the term “exemplary” is intended to refer to an example or illustration. As used herein, the terms “use,” “using,” and “used” may be considered synonymous with the terms “utilize,” “utilizing,” and “utilized,” respectively.

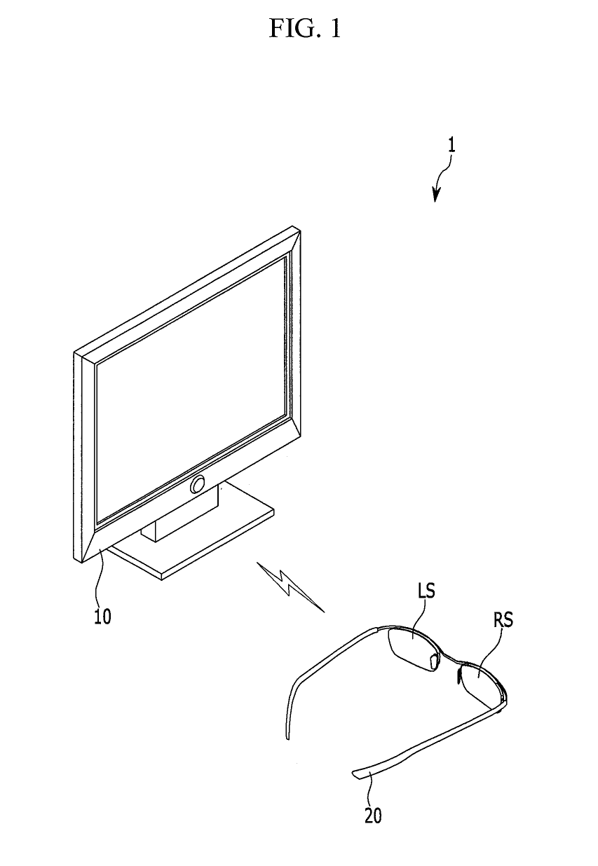

A display system in accordance with an exemplary embodiment of the present invention is described below with reference to FIG. 1.

FIG. 1 is a diagram illustrating the display system in accordance with an exemplary embodiment of the present invention.

Referring to FIG. 1, the display system 1 in accordance with an exemplary embodiment of the present invention includes a display device 10 and shutter glasses 20.

The display device 10 receives a stereoscopic image captured by a photographing device, such as a camera, or a stereoscopic image captured by a camera, edited/processed by a broadcasting station, and transmitted by the broadcasting station, processes the received stereoscopic image, and displays the processed image on a screen. The display device 10 is synchronized with the shutter glasses 20 using various communication methods, such as wireless infrared, and may send and receive various suitable signals.

The shutter glasses 20 are synchronized with the display device 10, and enable an image displayed on the display device 10 to be recognized in a three-dimensional way. The shutter glasses 20 include a left eye shutter LS and a right eye shutter RS.

The display system 1 may include a plurality of the shutter glasses 20, and the plurality of shutter glasses may operate in conjunction with a single display device 10. The display system 1 may support a remote controller (such as a QWERTY remote controller), a headset (such as 2A2DP stream), a portable phone including an application of a remote control function, a mouse device (such as a gestural remote controller), and/or a keyboard in addition to the shutter glasses 20. The display device 10 and the shutter glasses 20 may perform communication using a wireless communication method, such as Bluetooth communication, Zigbee communication, IR communication, or RF communication. The display device 10 and the shutter glasses 20 may communicate with each other and may be synchronized with the display device 10 through such wireless communication.

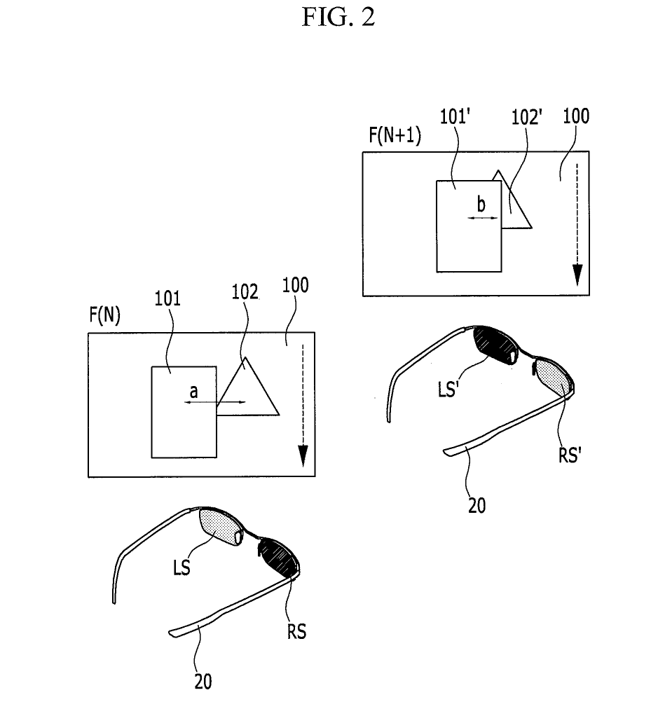

FIG. 2 is a diagram schematically illustrating an operation of the display system in accordance with an exemplary embodiment of the present invention.

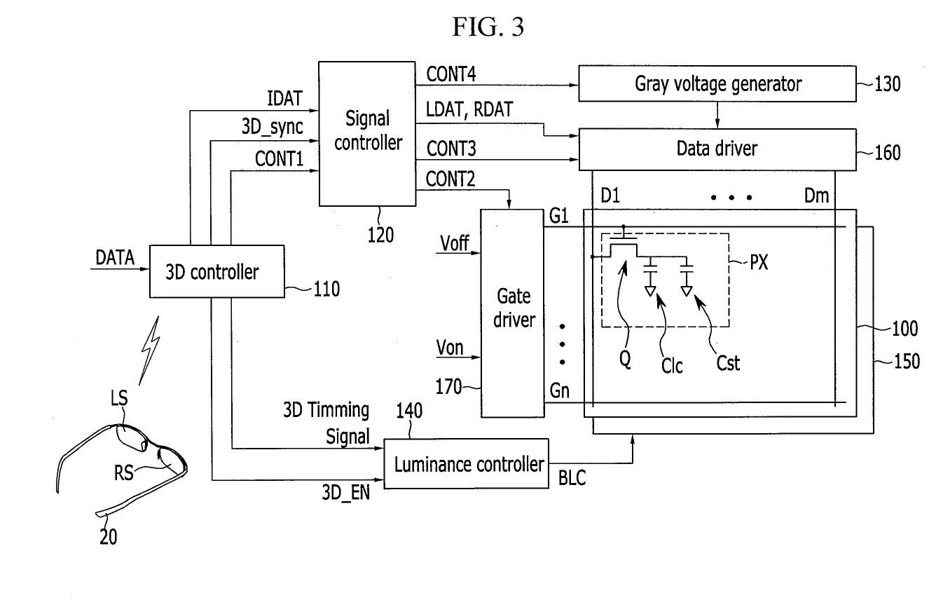

FIG. 3 is a block diagram of the display system in accordance with an exemplary embodiment of the present invention.

The display system in accordance with an exemplary embodiment of the present invention is described below with reference to FIGS. 2 and 3.

As shown in FIG. 3, the display device 10 may be a variety of types (kinds) of display devices, such as a Plasma Display Device (PDP), a Liquid Crystal Display (LCD), or an Organic Light-Emitting Device (OLED). The display device 10 is hereinafter assumed to be an LCD.

The display device 10 includes a display unit 100, a gate driver 170 and a data driver 160 connected to the display unit 100, a gray voltage generator 130 connected to the data driver 160, a signal controller 120 configured to control the aforementioned elements, a backlight unit 150 configured to supply light to the display unit 100, a luminance controller 140, and a 3D controller 110.

The display unit 100 includes a plurality of pixels PX connected to a plurality of display signal lines and arranged approximately in a matrix form. The display signal lines include a plurality of gate lines G1-Gn for transferring gate signals S[1]-S[n] and a plurality of data lines D1-Dm for transferring data signals D[1]-D[m]. Each of the pixels PX may include a switching elementQ such as a thin film transistor connected to each of the gate lines G1-Gn and each of the data lines D1-Dm, and a liquid crystal capacitor Clc and a storage capacitor Cst connected to the thin film transistor. The liquid crystal capacitor Clc includes two terminals, including a pixel electrode of a lower display unit for receiving data voltages from the data lines D1-Dm and a counter electrode of an upper display unit. A liquid crystal layer between the two electrodes functions as a dielectric material. The storage capacitor Cst functions as an auxiliary capacitor of the liquid crystal capacitor Clc and may be omitted. When a data voltage Vd is applied to the pixel electrode of the liquid crystal capacitor Clc, a voltage difference between a common voltage Vcom applied to the counter electrode and the data voltage Vd applied to the pixel electrode appears as the pixel voltage of each pixel PX. The liquid crystal molecules of a liquid crystal layer between the two electrodes are inclined in response to the pixel voltage. The degree that the polarization of light that passes through the liquid crystal layer is changed (is varied) depends on an inclined degree of the liquid crystal molecules. Accordingly, the pixel PX displays luminance indicative of a gray (a gray level) of an input image signal IDAT. The display unit 100 sequentially applies a gate-on voltage Von to all the gate lines G1-Gn and applies the data voltage Vd to all the pixels PX, thus displaying an image of a single frame F(N).

The 3D controller 110 receives external image information DATA and generates the input image signal IDAT, a 3D enable signal 3D_En, a 3D timing signal, a 3D sync signal 3D_sync including a left eye image sync signal Lsync and a right eye image sync signal Rsync, and an input control signal CONT1 that controls the display of the input image signal IDAT. The 3D controller 110 includes a communication module, and may be synchronized with the shutter glasses 20 using the communication module. The 3D controller 110 generates a vertical synchronization signal Vsync that classifies the frames of images, a horizontal synchronizing signal Hsync that classifies the lines of a single frame, a data enable signal DE that controls a period in which the data voltage Vd is applied to the plurality of data lines D1-Dm, and the input control signal CONT1 that controls an operation of displaying an image in response to a clock signal CLK that controls a driving frequency.

The signal controller 120 generates a left eye image signal LDAT, a right eye image signal LDAT, a gate control signal CONT2, a data control signal CONT3, and a gray voltage control signal CONT4 by properly processing the input image signal IDAT in accordance with the operating conditions of the display unit 100 in response to the input control signal CONT1 and the 3D sync signal 3D_sync.

The gray voltage generator 130 generates a gray reference voltage, including a positive value and a negative value for the common voltage Vcom, in response to the gray voltage control signal CONT4.

The luminance controller 140 generates a backlight control signal BLC in response to the 3D timing signal and the 3D enable signal 3D_En.

The backlight unit 150 includes a light source. The light source may include a fluorescent lamp, such as a Cold Cathode Fluorescent Lamp (CCFL), or an LED. The backlight unit 150 may be turned on or off in response to the backlight control signal BLC. The backlight unit 150 may emit light in response to the backlight control signal BLC during the period in which a left eye image or a right eye image is displayed on the display unit 100.

The data driver 160 is connected to the data lines D1-Dm of the display unit 100, and is configured to generate all gray voltages by dividing the gray reference voltage received from the gray voltage generator 130 and to select the data voltage Vd from the gray voltages. The data driver 160 selects a gray voltage, corresponding to each digital image signal DAT, from the gray reference voltage received from the gray voltage generator 130 in response to the data control signal CONT3, converts the digital image signal DAT into a plurality of data voltages D1-Dm by sampling and holding the digital image signal DAT, and applies the plurality of data voltages to the respective data lines D1-Dm in response to the data control signal CONT3.

The gate driver 170 is connected to the gate lines G1-Gn, and supplies the gate lines G1-Gn with gate signals G[1]-G[n] formed of combinations of the gate-on voltage Von and the gate-off voltage Voff. The gate driver 170 applies the gate-on voltage Von or the gate-off voltage Voff to the gate lines G1-Gn in response to the gate control signal CONT2.

An operation of the display system is described below with reference to FIGS. 2 and 3.

Referring to FIG. 2, the shutter glasses 20 in accordance with an exemplary embodiment of the present invention may be mechanical shutter glasses (goggles) or optical shutter glasses, but are not specially limited thereto.

The shutter glasses 20 are synchronized with the display device 10, and the right eye shutter (RS, RS′) and left eye shutter (LS, LS′) of the shutter glasses 20 alternately block light at a specific interval. The right eye shutter may be the right eye shutter RS of the closed state or the right eye shutter RS' of the open state, and the left eye shutter may be the left eye shutter LS of the open state or the left eye shutter LS' of the closed state. For example, when the right eye shutter is in the open state, the left eye shutter may be in the closed state. In contrast, when the left eye shutter is in the open state, the right eye shutter may be in the closed state. In addition, both the left eye shutter and the right eye shutter may be in the open state or the closed state.

A left eye image (101, 102) is output to the display unit 100, the left eye shutter LS of the shutter glasses 20 enters the open state in which light passes through the left eye shutter LS, and the right eye shutter RS enters the closed state in which light is blocked. Furthermore, a right eye image (101′, 102′) is output to the display unit 100, the right eye shutter RS' of the shutter glasses 20 enters the open state in which light passes through the right eye shutter RS′, and the left eye shutter LS' enters the closed state in which light is blocked. Accordingly, the left eye image is recognized by only the left eye for a specific time, and the right eye image is recognized by only the right eye for a next specific time. As a result, a stereoscopic image having a perception of depth is recognized due to a difference between the left eye image and the right eye image.

The image recognized by the left eye is an image displayed in an N-th frame F(N), that is, an image obtained when the left eye image 101 of a quadrangle is spaced apart from the left eye image 102 of a triangle at a distance a. The image recognized by the right eye is an image displayed in an (N+1)-th frame F(N+1), that is, an image obtained when the right eye image 101′ of a quadrangle is spaced apart from the right eye image 102′ of a triangle at a distance b. In this case, a and b may have different values. If an image recognized by one eye is spaced apart from an image recognized by the other eye as described above, a perception of distance is different for the quadrangle and triangle. Accordingly, there is a perception of depth because the triangle is placed behind the quadrangle. The perception of depth may be controlled by controlling the distances a and b.

A detailed operation of the shutter glasses 20 is described in more detail later.

Referring to FIGS. 2 and 3, the direction of an arrow indicated in the display unit 100 is indicative of order that the gate-on voltage Von is applied to the plurality of gate lines G1-Gn that extend approximately in a column direction. That is, the gate-on voltage Von may be sequentially applied to the first gate line G1 of the display device 10 to the last gate line Gn of the display device 10.

For example, the display unit 100 may display the left eye image (101, 102) as follows. The gate-on voltage Von is sequentially applied to the gate lines G1-Gn so that the data voltage Vd is applied to the pixel electrodes through the thin film transistors Q connected to the corresponding gate lines G1-Gn. In this case, the applied data voltage Vd is a data voltage for representing the left eye image (101, 102) (hereinafter referred to as a “left eye data voltage”). The applied left eye data voltage may be maintained for a specific time by the storage capacitor Cst. Likewise, a data voltage for representing the right eye image (101′, 102′) (hereinafter called a “right eye data voltage”) is applied. The applied right eye data voltage may be maintained for a specific time by the storage capacitor Cst.

In accordance with an exemplary embodiment of the present invention, the driving frequency of the display unit 100 may be 120 Hz, but is not limited thereto.

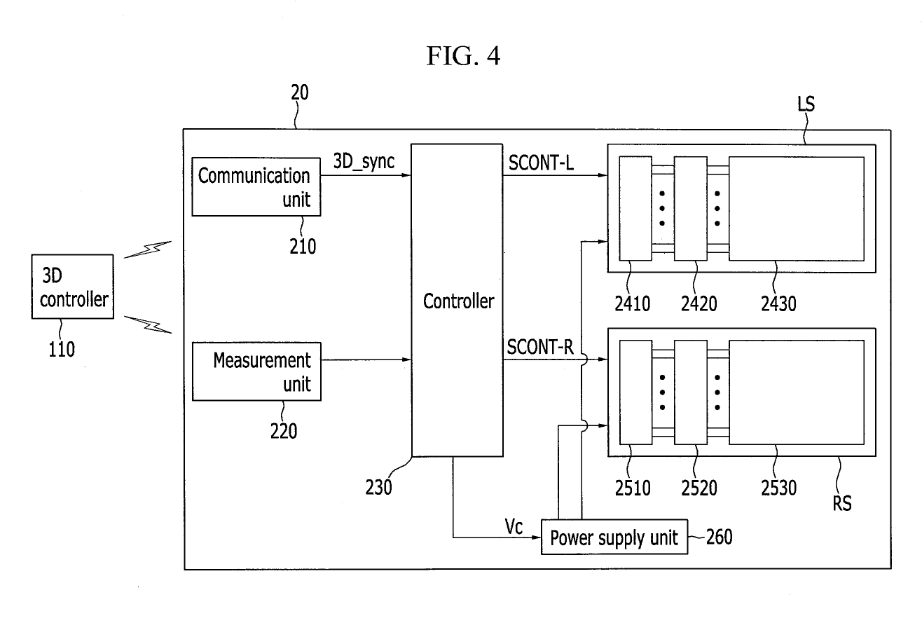

FIG. 4 is a block diagram of the shutter glasses in accordance with an exemplary embodiment of the present invention.

The shutter glasses in accordance with an exemplary embodiment of the present invention are described below with reference to FIG. 4.

Referring to FIG. 4, the shutter glasses 20 include a communication unit 210, a measurement unit 220, a controller 230, a power supply unit 260, the left eye shutter LS, and the right eye shutter RS.

The communication unit 210 receives the 3D sync signal 3D_sync and sends the 3D sync signal 3D_sync to the controller 230.

The measurement unit 220 may measure the distance between the pupil of a user and the display unit 100, an actual viewing range, and user location information including an angle up to the viewpoint of the display unit 100.

The controller 230 generates a voltage control signal Vc, a left eye shutter control signal SCONT_L, and a right eye shutter control signal SCONT_R. The controller 230 may calculate a viewing distance using the distance between the pupil of the user and the display unit 100, and control the shutoff time of the left eye shutter LS or right eye shutter RS based on the user location information.

The power supply unit 260 supplies the driving voltage Vd in response to the voltage control signal Vc of the controller 230 so that the left eye shutter LS and the right eye shutter RS are open or shut.

The left eye shutter LS includes a shutter driving unit 2410, a shutter driving circuit 2420, and a left eye shutter lens 2430. The right eye shutter RS includes a shutter driving unit 2510, a shutter driving circuit 2520, and a right eye shutter lens 2530.

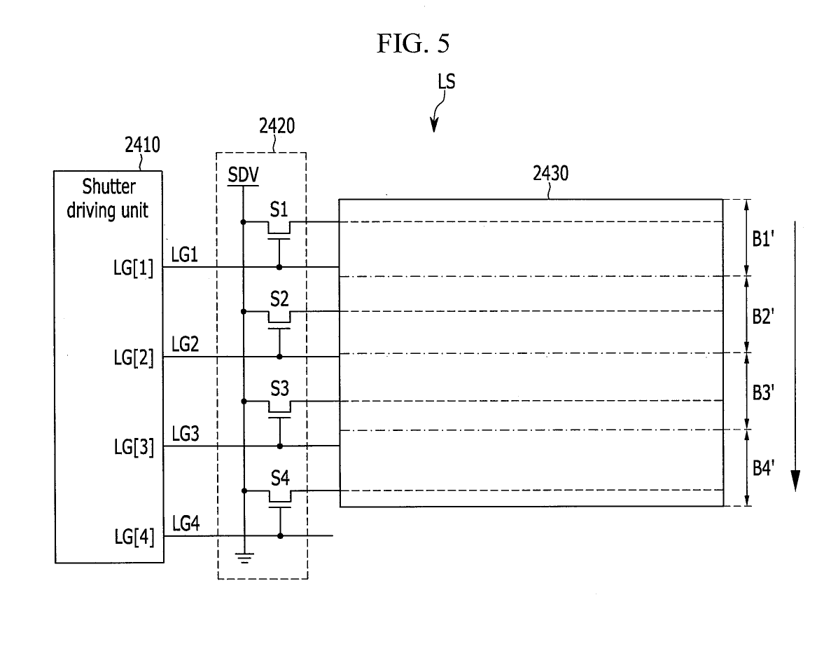

The right and left eye shutter lenses 2430 and 2530 may be driven according to each block (e.g., each predetermined block) in response to the scan speed of the display unit 100 of the shutter driving units 2410 and 2510 (see, e.g., FIG. 5).

FIG. 5 is a diagram illustrating the left eye shutter in accordance with an exemplary embodiment of the present invention.

The operation of the left eye shutter LS is described below with reference to FIG. 5.

Referring to FIG. 5, the left eye shutter LS includes a shutter driving unit 2410, a plurality of left eye gate lines LG1-LG4 extended in a column direction, a shutter driving circuit 2420 configured to include switches S1-S4, and a liquid crystal shutter lens (a liquid crystal shutter) 2430.

The shutter driving unit 2410 supplies the left eye gate lines LG1-LG4n with left eye gate signals LG[1]-LG[4] formed of combinations of the gate-on voltage Von and the gate-off voltage Voff. The shutter driving unit 2410 applies the gate-on voltage Von or the gate-off voltage Voff to the gate lines G1-Gn in response to the left eye shutter control signal SCONT_L.

The driving circuit 2420 includes a switch S1 having an input terminal connected to a shutter driving voltage line SDV, a gate connected to the left eye gate line LG1, and an output terminal connected to the liquid crystal shutter lens 2430, a switch S2 having an input terminal connected to the shutter driving voltage line SDV, a gate connected to the left eye gate line LG2, and an output terminal connected to the liquid crystal shutter lens 2430, a switch S3 having an input terminal connected to the shutter driving voltage line SDV, a gate connected to the left eye gate line LG3, and an output terminal connected to the liquid crystal shutter lens 2430, and a switch S4 having an input terminal connected to the shutter driving voltage line SDV, a gate connected to the left eye gate line LG4, and an output terminal connected to the liquid crystal shutter lens 2430.

The liquid crystal shutter lens 2430 includes a block B1′ turned on or off in response to the shutter driving voltage SDV applied through the switch S1, a block B2′ turned on or off in response to the shutter driving voltage SDV applied through the switch S2, a block B3′ turned on or off in response to the shutter driving voltage SDV applied through the switch S3, and a block B4′ turned on or off in response to the shutter driving voltage SDV applied through the switch S4. The liquid crystal shutter lens 2430 has been illustrated as being divided into the four blocks B1′-B4′, for convenience of description, but an exemplary embodiment of the present invention is not limited thereto. The liquid crystal shutter lens 2430 may be divided into 4k blocks corresponding to the gate lines of the display unit 100.

The direction of an arrow indicated in the liquid crystal shutter lens 2430 is indicative of order that the gate-on voltage Von is applied to the left eye gate lines LG1-LGn. That is, the gate-on voltage Von may be sequentially applied to the first left eye gate line LG1 to the last left eye gate line LGn of the driving circuit 2420. However, an exemplary embodiment of the present invention is not limited thereto. For example, the gate-on voltage Von may not be sequentially applied to the first left eye gate line LG1 to the last left eye gate line LGn of the driving circuit 2420.

The shutter driving unit 2510, the shutter driving circuit 2520, and the right eye shutter lens 2530 of the right eye shutter RS have the same configurations and functions as the shutter driving unit 2410, the shutter driving circuit 2420, and the left eye shutter lens 2430 of the left eye shutter LS, and thus detailed descriptions thereof are omitted.

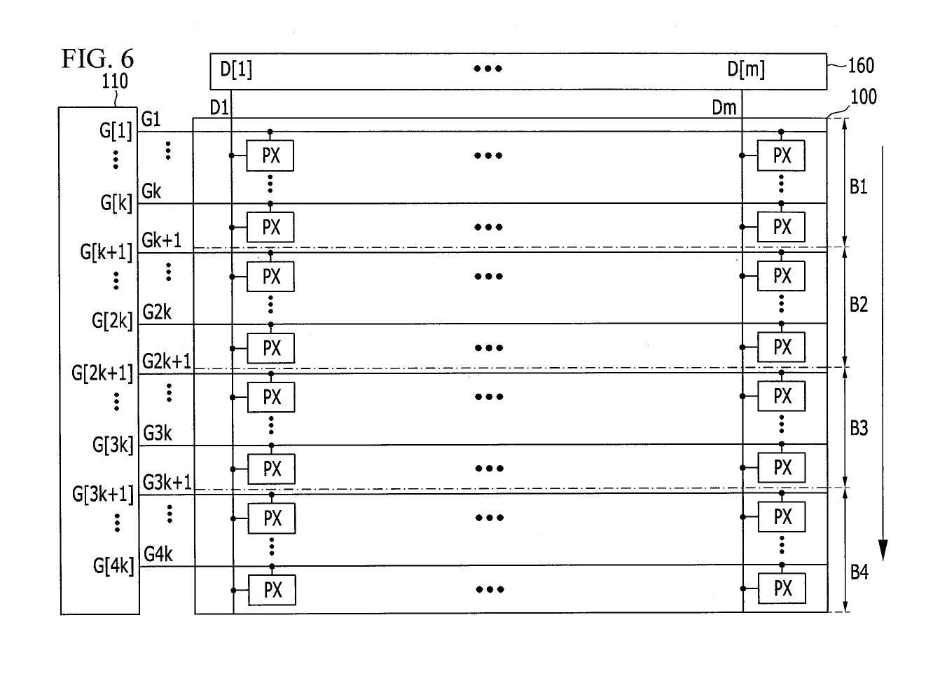

FIG. 6 is a diagram illustrating the display unit in accordance with an exemplary embodiment of the present invention.

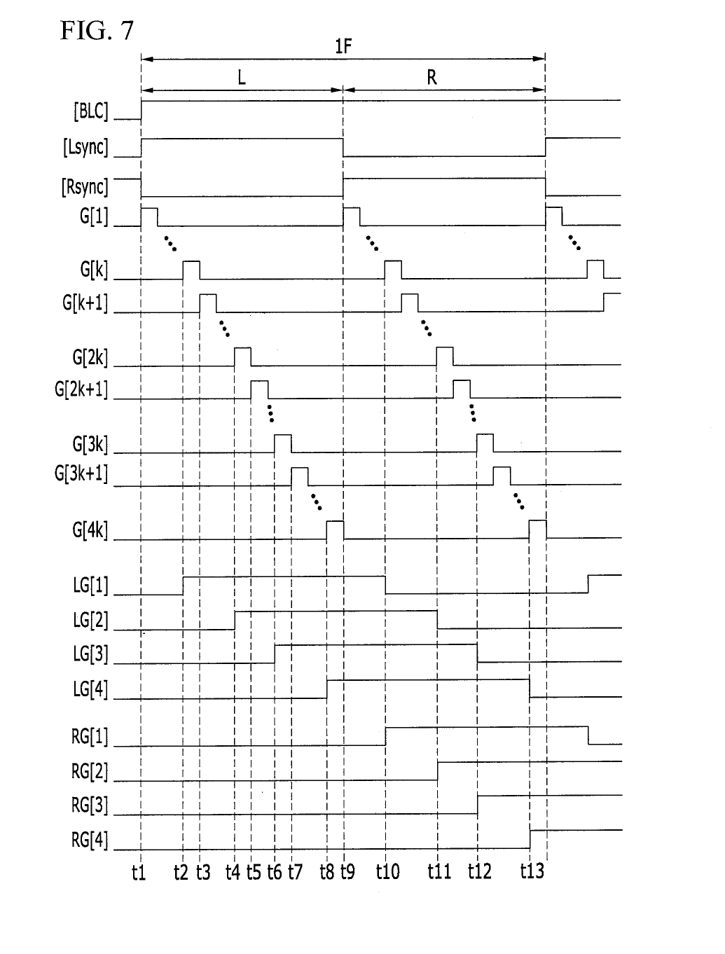

FIG. 7 is a diagram illustrating the driving timing of the shutter glasses in accordance with an exemplary embodiment of the present invention.

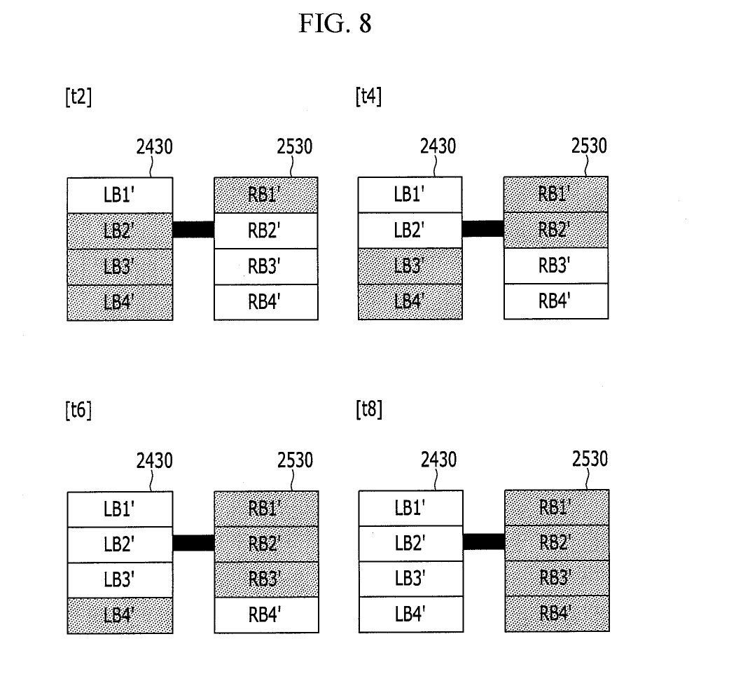

FIG. 8 provides diagrams illustrating an operation of the shutter glasses in accordance with an exemplary embodiment of the present invention.

The operation of the shutter glasses is described below with reference to FIGS. 6 to 8.

Referring to FIG. 6, the display unit 100 may include a block B1 including gate lines G1-Gk, a block B2 including gate lines Gk+1−G2k, a block B3 including gate lines G2k+1−G3k, and a block B4 including gate lines G3k+1−G4k.

Referring to FIGS. 7 and 8, for a unit frame 1F, a left eye image is displayed on the display unit 100 in response to the left eye image sync signal Lsync, and a right eye image is displayed on the display unit 100 in response to the right eye image sync signal Rsync.

First, at a point of time t1, a left eye image signal is displayed on the display unit 100 in response to the left eye image sync signal Lsync. Furthermore, at the point of time t1, the gate driver 170 sequentially applies the gate signals G[1] to G[k] corresponding to the gate line G1 to the gate line Gk, respectively. At a point of time t2 at which the gate signal G[k] is applied to the gate line Gk, the shutter driving unit 2410 applies the gate-on signal LG[1] to the left eye gate line LG1. The switch S1 is turned on in response to the left eye gate-on signal LG[1], and thus the shutter driving voltage SDV of an enable level is applied to the block B1′ (e.g., block LB1′ in FIG. 8) through the switch S1, thereby turning on the block B1′ of the left eye shutter lens 2430. Accordingly, the block B1′ transmits a left eye image of the block B1. At this time, the shutter driving unit 2410 applies the gate-off signal so that the block RB1′ of the right eye shutter lens 2530 is turned off. The switch S1 turned on at the point of time t2 is turned off at a point of time t10 at which the right eye image gate signal G[k] is applied to the gate line Gk.

At a point of time t3, the gate driver 170 sequentially applies the gate signals G[k+1] to G[2k] corresponding to the gate line Gk+1 to the gate line G2k1, respectively. At a point of time t4 at which the gate signal G[2k] is applied to the gate line G2k, the shutter driving unit 2410 applies the gate-on signal LG[2] to the left eye gate line LG2. The switch S2 is turned on in response to the left eye gate-on signal LG[2], and the shutter driving voltage SDV of an enable level is applied to the block B2′ (e.g., block LB2′ in FIG. 8) through the switch S2, thereby turning on the block B2′ of the left eye shutter lens 2430. Accordingly, the block B2′ transmits a left eye image of the block B2. At this time, the shutter driving unit 2410 applies the gate-off signal so that the block RB2′ of the right eye shutter lens 2530 is turned off. The switch S2 turned on at the point of time t4 is turned off at a point of time t11 at which the right eye image gate signal G[2k] is applied to the gate line G2k.

At a point of time t5, the gate driver 170 sequentially applies the gate signals G[2k+1] to G[3k] corresponding to the gate line G2k+1 to the gate line G3k, respectively. At a point of time t6 at which the gate signal G[3k] is applied to the gate line G3k, the shutter driving unit 2410 applies the gate-on signal LG[3] to the left eye gate line LG3. The switch S3 is turned on in response to the left eye gate-on signal LG[3], and the shutter driving voltage SDV of an enable level is applied to the block B3′ (e.g., block LB3′ in FIG. 8) through the switch S3, thereby turning on the block B3′ of the left eye shutter lens 2430. Accordingly, the block B3′ transmits the left eye image of the block B3. At this time, the shutter driving unit 2410 applies the gate-off signal so that the block RB3′ of the right eye shutter lens 2530 is turned off. The switch S3 turned on at the point of time t6 is turned off at a point of time t12 at which the right eye image gate signal G[3k] is applied to the gate line G3k.

At a point of time t7, the gate driver 170 sequentially applies the gate signals G[3k+1] to G[4k] corresponding to the gate line G3k+1 to the gate line G4k, respectively. At a point of time t8 at which the gate signal G[4k] is applied to the gate line G4k, the shutter driving unit 2410 applies the gate-on signal LG[4] to the left eye gate line LG4. The switch S42 is turned on in response to the left eye gate-on signal LG[4], and the shutter driving voltage SDV of an enable level is applied to the block B4′ (e.g., block LB4′ in FIG. 8) through the switch S4, thereby turning on the block B4′ of the left eye shutter lens 2430. Accordingly, the block B4′ transmits a left eye image of the block B4. At this time, the shutter driving unit 2410 applies the gate-off signal so that the block RB4′ of the right eye shutter lens 2530 is turned off. The switch S4 turned on at the point of time t8 is turned off at a point of time t13 at which the right eye image gate signal G[4k] is applied to the gate line G4k.

Thereafter, at a point of time t9, a right eye image signal is displayed on the display unit 100 in response to the right eye image sync signal Rsync. Furthermore, at the point of time t9, the gate driver 170 applies the gate signals G[1] to G[k] corresponding to the gate line G1 to the gate line Gk. Thereafter, a method in which the right eye shutter lens 2530 transmits a right eye image of the display unit 100 is the same as that of the left eye shutter lens 2430, and thus a detailed description thereof is omitted.

The left eye or right eye gate signal has been illustrated as being applied at the points of time t2, t4, t6, and t8 at which the last gate signals G[k], G[2k], G[3k], and G[4k] of the respective blocks B1 to B4 of the display unit 100 are applied, but an exemplary embodiment of the present invention is not limited thereto. A corresponding left eye or right eye gate-on signal may be applied: at the points of time t1, t3, t5, and t7 at which the first gate signals G[1], G[k+1], G[2k+1], and G[3k+1] of the respective blocks of the display unit 100 are applied; or at the points of time t3, t5, t7, and t9 at which the first gate signals G[k+1], G[2k+1], G[3k+1], and G[4k+1] of blocks (e.g., B2, that is, a block next to the block B1 corresponding to B1′) next to the blocks of the display unit corresponding to the blocks of the shutter lens are applied).

Furthermore, the display unit 100 has been illustrated as being divided into four equal parts, and the blocks B1-B4 and a corresponding shutter lens (2430, 2530) divided into four equal parts have been illustrated as forming the blocks B1′-B4′, for convenience of description, but an exemplary embodiment of the present invention is not limited thereto. For example, a block of the display unit 100 may be divided into 4k equal parts corresponding to the gate lines G1-G4k, and a corresponding block of the shutter lens (2430, 2530) may be divided into 4l equal parts. In this case, the left eye shutter LS may include left eye gate lines LG1-LG4l and switches S1-S4l, and the right eye shutter RS may include right eye gate lines RG1-RG4l and switches S1-S4l. In such a case, the blocks B1′-B4k′ of the left eye shutter lens 2430 and the right eye shutter lens 2530 may be turned on at the same points of time as points of time at which the gate signals G[1]-G[4k] are applied to the respective gate lines G1-G4k of the display unit 100, and may be turned off at points of time at which the gate signals G[1]-G[4k] are not applied.

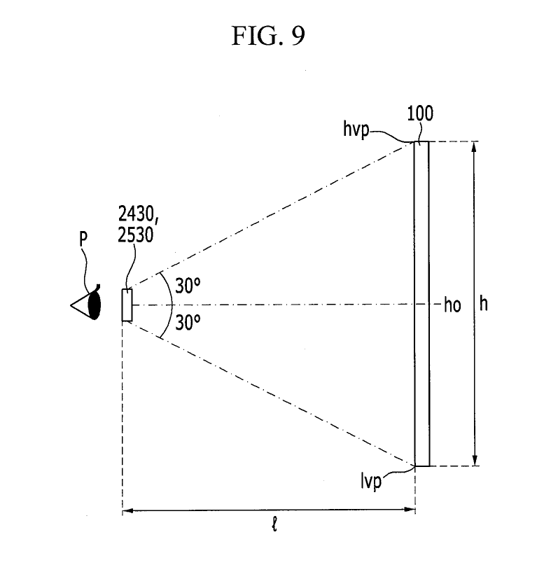

FIG. 9 is a diagram illustrating the upper and lower viewing angles of a user.

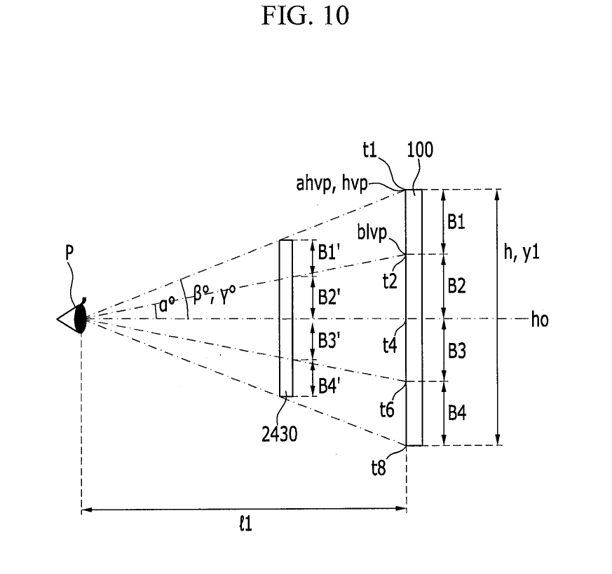

FIG. 10 is a diagram illustrating the operation of the shutter glasses when an actual viewing range is equal to the height of the display unit.

An operation of the shutter glasses when an actual viewing range is equal to the height of the display unit is described below with reference to FIGS. 9 and 10.

Referring to FIG. 9, a user has a total of a 60-degree viewing angle on the basis of a horizontal line ho, including an upper viewing angle of 30 degrees up to the highest viewpoint hvp of the display unit 100 and a lower viewing angle of 30 degrees down to the lowest viewpoint lvp of the display unit 100. The controller 230 may calculate an actual viewing range y in accordance with Equation 1 using the height h of the display unit 100 and the distance l between the display unit 100 and the pupil P of the user.

y=1.15*l(tan30°=y/2/l, y=2/3*√3*l) Equation 1

In this case, a method of driving the shutter glasses 20 may be divided into three types depending on the value of the actual viewing range y. That is, the three types include a case where the actual viewing range y is equal to the height h of the display unit 100 (y=h), a case where the actual viewing range y is less than the height h of the display unit 100 (y<h), and a case where the actual viewing range y is more than the height h of the display unit 100 (y>h).

Referring to FIG. 10, the measurement unit 220 may measure an angle α° down to the lowest viewpoint blvp of the block B1 on the basis of the horizontal line ho of the pupil P. In this case, the lowest viewpoint blvp of the block B1 may correspond to the last gate line of the block B1 of the display unit 100. Furthermore, the measurement unit 220 may measure an angle β° up to the highest viewpoint hvp of the display unit 100 on the basis of the horizontal line ho, and an angle γ° up to the highest viewpoint ahvp of the actual viewing range y on the basis of the horizontal line ho. In this case, the highest viewpoint hvp of the display unit 100 may correspond to the first gate line of the display unit 100. Since an actual viewing range y1 is equal to the height h, the highest viewpoint hvp and the highest viewpoint ahvp are the same.

The controller 230 may calculate the length of the block B1 using Equation 2 below.

B1=(l1*tan β°)−(l1*tan α°)=l1*(tan β° tan α°) Equation 2

Furthermore, the controller 230 may calculate the operating speed s of the left eye shutter lens 2430 using Equation 3 below.

s=B1/t(data scan speed s=l/t(t=1/f), f: the driving frequency of the display unit 100) Equation 3

The controller 230 may calculate a point of time t2, a point of time t6, and a point of time t8 using Equation 4 below.

t2=t1+B1/s, t4=t2+B1/s, t6=t4+B1/s, t8=t6+B1/s Equation 4

In this case, the point of time t2, the point of time t6, and the point of time t8 are the same as the point of time t2, the point of time t6, and the point of time t8 in FIG. 7. The controller 230 may perform control so that the first switch S1 of the left eye shutter LS is turned on at the point of time t2. Thereafter, the controller 230 may perform control so that the second switch S2, the third switch S3, and the fourth switch S4 are sequentially turned on at the point of time t4, at the point of time t6, and at the point of time t8, respectively.

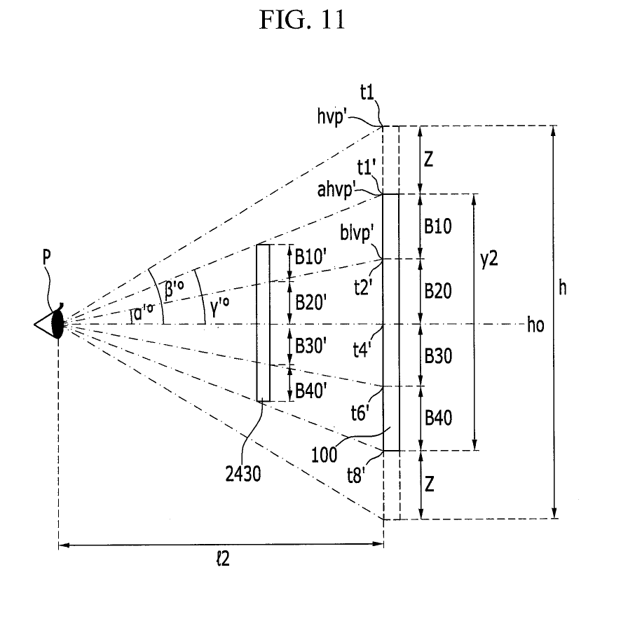

FIG. 11 is a diagram illustrating the operation of the shutter glasses when an actual viewing range is less than the height of the display unit.

The operation of the shutter glasses when an actual viewing range y2 is less than the height h (y2<h) is described below with reference to FIG. 11.

Referring to FIG. 11, the measurement unit 220 may measure an angle α′° down to the lowest viewpoint blvp′ of the block B10 on the basis of the horizontal line ho of a pupil P. In this case, the lowest viewpoint blvp′ of the block B10 may correspond to the last gate line of the block B10 of the display unit 100. Furthermore, the measurement unit 220 may measure an angle β′° up to the highest viewpoint hvp′ of the display unit 100 on the basis of the horizontal line ho and an angle γ′° the highest viewpoint ahvp′ of the actual viewing range y2 on the basis of the horizontal line ho. In this case, the highest viewpoint hvp′ of the display unit 100 may correspond to the first gate line of the display unit 100. Since the height h is more than the actual viewing range y2, the highest viewpoint hvp′ is higher than the highest viewpoint ahvp′.

The controller 230 may calculate a delay distance Z and the length of the block B10 using Equation 5 below.

z=l2*(tan γ°′−tan β), B10=l2*(tan β′°−tan α′°) Equation 5

Furthermore, the controller 230 may calculate a point of time t1′ earlier than the point of time t1 of FIG. 7, and calculate a point of time t2′, a point of time t4′, a point of time t6′, and a point of time t8′ using Equation 6 below.

t1′=t1+z/s, t2′=t1′+(B10/s), t4′=t2′+(B10/s), t6′=t4′+(B10/s), t8′=t6′+(B10/s) Equation 6

The controller 230 may perform control so that the first switch S1 of the left eye shutter LS is turned on at the point of time t2′. Thereafter, the controller 230 may perform control so that the second switch S2, the third switch S3, and the fourth switch S4 are sequentially turned on at the point of time t4′, the point of time t6′, and the point of time t8′, respectively.

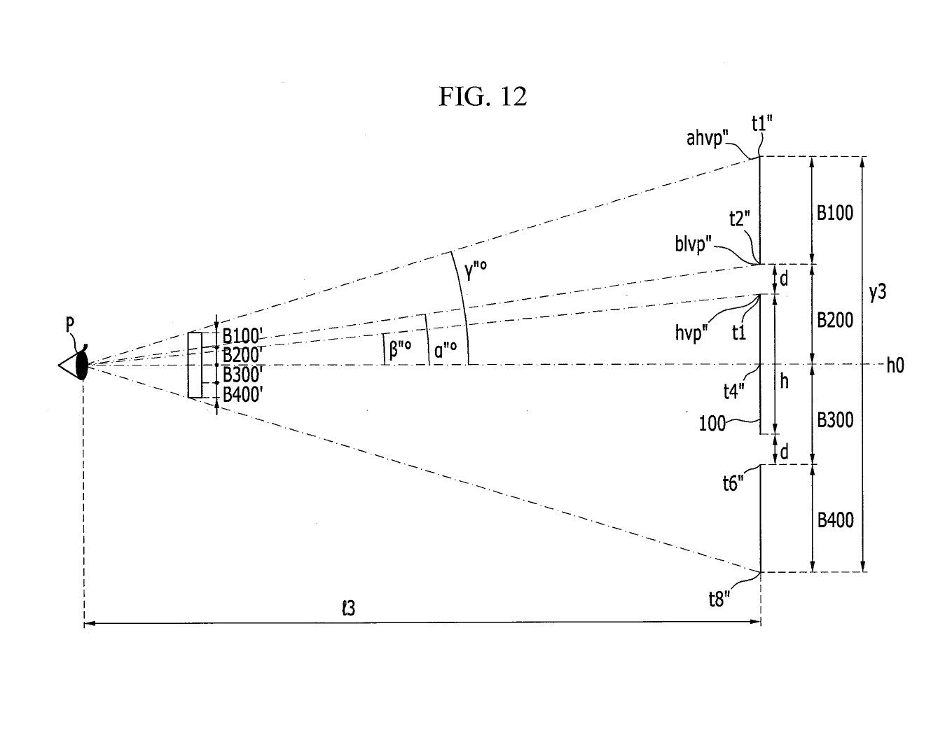

FIG. 12 is a diagram illustrating the operation of the shutter glasses when an actual viewing range exceeds the height of the display unit.

The operation of the shutter glasses when an actual viewing range y3 exceeds the height h of the display unit 100 (y3>h) is described below with reference to FIG. 12.

Referring to FIG. 12, the measurement unit 220 may measure an angle α″° down to the lowest viewpoint blvp″ of a block B100 on the basis of the horizontal line ho of a pupil P. In this case, the lowest viewpoint blvp″ of the block B100 may correspond to the last gate line of the block B100 of the display unit 100. Furthermore, the measurement unit 220 may measure an angle β″° up to the highest viewpoint hvp″ of the display unit 100 on the basis of the horizontal line ho and an angle γ″° up to the highest viewpoint ahvp″ of the actual viewing range y3 on the basis of the horizontal line ho. In this case, the highest viewpoint hvp″ of the display unit 100 may correspond to the first gate line of the display unit 100. Since the height h is less than the actual viewing range y3, the highest viewpoint ahvp″ is lower than the highest viewpoint hvp″.

The controller 230 may calculate the length of the block B100 and a preceding length d using Equation 7 below.

B100=l3*(tan β″°−tan α″°), d=l3*(tan α″°−tan γ″°) Equation 7

The controller 230 may calculate a point of time t1″ earlier than at the point of time t1 of FIG. 7, and calculate a point of time t2″, a point of time t4″, a point of time t6″, and a point of time t8″ using Equation 8 below.

t1″=t1−(B100+d)/s, t2″=t1−(d/s), t4″=t2″+(B100/s), t6″=t4″+(B100/s), t8″=t6″+(B100/s) Equation 8

The controller 230 may perform control so that the first switch S1 of the left eye shutter LS or the right eye shutter RS is previously turned on at the point of time t2″. Thereafter, the controller 230 may perform control so that the second switch S2, the third switch S3, and the fourth switch S4 are sequentially turned on at the point of time t4″, the point of time t6″, and the point of time t8″, respectively.

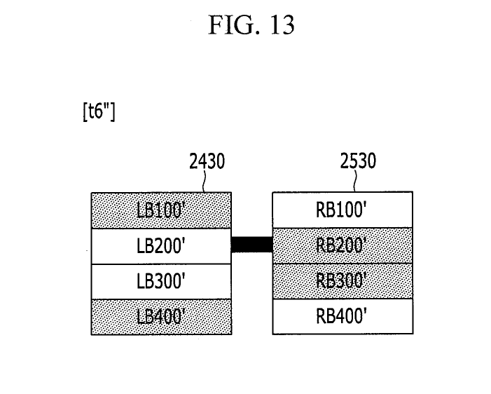

FIG. 13 is a diagram illustrating an operation of the shutter glasses in accordance with another exemplary embodiment of the present invention.

The operation of the shutter glasses in accordance with another exemplary embodiment of the present invention is described below with reference to FIG. 13.

The controller 230 may sequentially drive the blocks LB100′ to LB400′ of the left eye shutter LS, but an exemplary embodiment of the present invention is not limited thereto. If the actual viewing range y exceeds the height h of the display unit 100 (y>h) as described with reference to FIG. 12, the controller 230 may randomly perform control so that the block LB100′ is turned off and the block RB100′ is turned on before the block LB400′ is turned on at the point of time t6″.

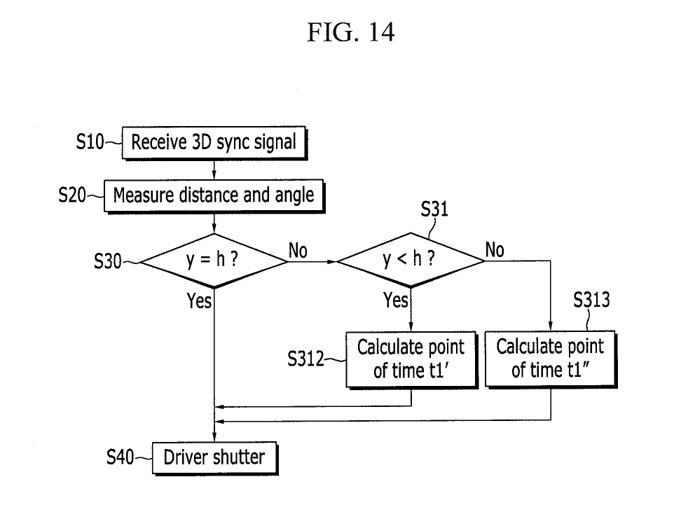

FIG. 14 is a flowchart illustrating an operation of the shutter glasses in accordance with an exemplary embodiment of the present invention.

A method of driving the shutter glasses in accordance with an exemplary embodiment of the present invention is described below with reference to FIG. 14.

At act S10, the controller 230 synchronizes the shutter glasses 20 and the display device 10 in response to the 3D sync signal 3D_sync.

At act S20, the measurement unit 220 may measure the angle α° down to the lowest viewpoint blvp of the block B1 on the basis of the horizontal line ho of the pupil P. Furthermore, the measurement unit 220 may measure the angle β° up to the highest viewpoint hvp of the display unit 100 on the basis of the horizontal line ho and measure the angle γ° up to the highest viewpoint ahvp of the actual viewing range y on the basis of the horizontal line ho.

At acts S30 and S31, the controller 230 determines whether an actual viewing range y is equal to the height h of the display unit 100 (y=h), whether the actual viewing range y is less than the height h of the display unit 100 (y<h), and whether the actual viewing range y is more than the height h of the display unit 100 (y>h).

If the actual viewing range y is equal to the height h of the display unit 100 at act S30, the controller 230 calculates the length of the block B1 and the operating speed s of the shutter lens (2430, 2530).

At act S40, the controller 230 may drive the first switch S1 of the left eye shutter LS or the right eye shutter RS so that the first switch S1 is turned on at the point of time t2. Thereafter, the controller 230 may drive the second switch S2, the third switch S3, and the fourth switch S4 so that they are sequentially turned on at the point of time t4, the point of time t6, and the point of time t8, respectively.

If the actual viewing range y is less than the height h of the display unit 100, at act S312, the controller 230 calculates the delay distance Z and the length of the block B10, calculates the point of time t1′ earlier than the point of time t1, and calculates the point of time t2′, the point of time t4′, the point of time t6′, and the point of time t8′.

At act S40, the controller 230 may drive the first switch S1 of the left eye shutter LS or the right eye shutter RS so that the first switch S1 is turned on at the point of time t2′. Thereafter, the controller 230 may drive the second switch S2, the third switch S3, and the fourth switch S4 so that they are sequentially turned on at the point of time t4′, the point of time t6′, and the point of time t8′, respectively.

If the actual viewing range y is more than the height h of the display unit 100, at act S313, the controller 230 may calculate the length of the block B100 and a preceding length d, may calculate the point of time t1″ earlier than the point of time t1, and may calculate the point of time t2″, the point of time t4″, the point of time t6″, and the point of time t8″.

At act S40, the controller 230 may drive the first switch S1 of the left eye shutter LS or the right eye shutter RS so that the first switch S1 is previously turned on at the point of time t2″. Thereafter, the controller 230 may drive the second switch S2, the third switch S3, and the fourth switch S3 so that they are sequentially turned on at the point of time t4″, the point of time t6″, and the point of time t8″.

The exemplary embodiments of the present invention have been described in detail, but the scope of the present invention is not limited thereto. The scope of the present invention also includes a variety of modifications and changes that are to be performed by a person having ordinary skill in the art and that are defined in the appended claims, and equivalents thereof. Accordingly, the detailed description should not be construed as being limitative from all aspects, but should be construed as being illustrative. The scope of the present invention should be determined by reasonable analysis of the attached claims, and all changes within the equivalent range of the present invention are included in the scope of the present invention.

### DESCRIPTION OF SYMBOLS

10: display device
20: shutter glasses
100: display unit
110: 3D controller
120: signal controller
130: gray voltage generator
140: luminance controller
150: backlight unit
160: data driver
170: gate driver
2430: left eye shutter lens
2530: right eye shutter lens
RS, RS′: right eye shutter
LS, LS′: left eye shutter

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. Shutter glasses, comprising:
a shutter lens configured to transmit an image of a display unit; and
a controller configured to control shutoff of the shutter lens,
wherein the shutter lens comprises a first shutter block and a second shutter block, and
the controller is configured to:
control shutoff of the first shutter block in response to an image of a first display block of the display unit, and
control shutoff of the second shutter block in response to an image of a second display block of the display unit.

2. The shutter glasses of claim 1, wherein:
the display unit is configured to alternately display a left eye image and a right eye image;
the shutter lens comprises a left eye shutter lens and a right eye shutter lens; and
the controller is configured to:
control shutoff of the left eye shutter lens in response to the left eye image, and
control shutoff of the right eye shutter lens in response to the right eye image.

3. The shutter glasses of claim 1, further comprising
a measurement unit configured to measure user location information,
wherein the user location information comprises a distance between a pupil of a user and the display unit, an actual viewing range according to the distance, a first angle from the pupil to a lowest viewpoint of the first display block, a second angle from the pupil to a highest viewpoint of the display unit, and a third angle from the pupil to a highest viewpoint of the actual viewing range, and
the controller is configured to control points of time of the shutoff of the first shutter block and the second shutter block based on the user location information.

4. The shutter glasses of claim 3, wherein:
the actual viewing range comprises a first viewing range block; and
the controller is configured to:
calculate a length of the first viewing range block utilizing the first angle and the second angle, and
control the first shutter block utilizing the length of the first viewing range block so that the first shutter block is open at a first point of time.

5. The shutter glasses of claim 4, wherein the controller is configured to calculate the length of the first viewing range block utilizing the first angle and the third angle.

6. The shutter glasses of claim 4, wherein the lowest viewpoint of the first display block is identical with the highest viewpoint of the display unit.

7. The shutter glasses of claim 4, wherein:
the actual viewing range comprises a second viewing range block;
the user location information comprises a fourth angle from the pupil to a lowest viewpoint of the second viewing range block, a fifth angle from the pupil to the highest viewpoint of the display unit, and a sixth angle from the pupil to a highest viewpoint of the second viewing range block; and
the controller is configured to:
calculate a length of the second viewing range block utilizing the fifth angle and the sixth angle,
calculate a delay length utilizing the fourth angle and the fifth angle,
calculate a second point of time utilizing the length of the second viewing range block and the delay length, and
control the first shutter block so that the first shutter block is open at the second point of time.

8. The shutter glasses of claim 7, wherein the second point of time is earlier than the first point of time.

9. The shutter glasses of claim 7, wherein the highest viewpoint of the display unit is higher than the highest viewpoint of the actual viewing range.

10. The shutter glasses of claim 4, wherein:
the actual viewing range comprises a third viewing range block;
the user location information comprises a seventh angle from the pupil to a lowest viewpoint of the third viewing range block, an eighth angle from the pupil to the highest viewpoint of the display unit, and a ninth angle from the pupil to a highest viewpoint of the third viewing range block; and
the controller is configured to:
calculate a length of the third viewing range block utilizing the seventh angle and the eighth angle,
calculate a preceding length utilizing the seventh angle and the ninth angle,
calculate a corresponding third point of time utilizing the length of the third viewing range block and the preceding length, and
control the first shutter block so that the first shutter block is open at the third point of time.

11. The shutter glasses of claim 10, wherein the third point of time is later than the first point of time.

12. The shutter glasses of claim 10, wherein the highest viewpoint of the display unit is lower than the highest viewpoint of the actual viewing range.

13. A method of driving shutter glasses comprising a shutter lens configured to comprise a first shutter block and a second shutter block, a measurement unit configured to measure user location information, and a controller configured to control a shutoff of the shutter lens,
the method comprising:
measuring user location information;
controlling shutoff of the first shutter block in response to an image of a first display block of a display unit; and
controlling shutoff of the second shutter block in response to an image of a second display block of the display unit.

14. The method of claim 13, wherein:
the display unit alternately displays a left eye image and a right eye image;
the shutter lens comprises a left eye shutter lens and a right eye shutter lens; and
the controller controls shutoff of the left eye shutter lens in response to the left eye image and controls shutoff of the right eye shutter lens in response to the right eye image.

15. The method of claim 13, wherein
the measuring of the user location information comprises:
measuring a distance between a pupil of a user and the display unit; and
measuring an actual viewing range according to the distance, a first angle from the pupil to a lowest viewpoint of the first display block, a second angle from the pupil to a highest viewpoint of the display unit, and a third angle from the pupil to a highest viewpoint of the actual viewing range, and
the controlling of the shutoff comprises:
controlling a point of time of the shutoff of the first shutter block and the second shutter block based on the user location information.

16. The method of claim 15, wherein
the actual viewing range comprises a first viewing range block, and
the controlling of the point of time of the shutoff of the first shutter block comprises:
calculating a length of the first viewing range block utilizing the first angle and the second angle;
calculating a first point of time utilizing the length of the first viewing range block; and
driving the first shutter block so that the first shutter block is open at the first point of time.

17. The method of claim 16, wherein the lowest viewpoint of the first display block is identical with the highest viewpoint of the display unit.

18. The method of claim 16, wherein
the actual viewing range comprises a second viewing range block,
the user location information comprises a fourth angle from the pupil to a lowest viewpoint of the second viewing range block, a fifth angle from the pupil to the highest viewpoint of the display unit, and a sixth angle from the pupil to a highest viewpoint of the second viewing range block, and
the controlling of the point of time of the shutoff of the first shutter block comprises:
calculating a length of the second viewing range block utilizing the fifth angle and the sixth angle;
calculating a delay length utilizing the fourth angle and the fifth angle;
calculating a corresponding second point of time utilizing the length of the second viewing range block and the delay length; and
driving the first shutter block so that the first shutter block is open at the second point of time.

19. The method of claim 18, wherein the second point of time is earlier than the first point of time.

20. The method of claim 18, wherein the highest viewpoint of the display unit is higher than the highest viewpoint of the actual viewing range.

21. The method of claim 16, wherein
the actual viewing range comprises a third viewing range block,
the user location information comprises a seventh angle from the pupil to a lowest viewpoint of the third viewing range block, an eighth angle from the pupil to the highest viewpoint of the display unit, and a ninth angle from the pupil to a highest viewpoint of the third viewing range block, and
the controlling of the point of time of the shutoff of the first shutter block comprises:
calculating a length of the third viewing range block utilizing the seventh angle and the eighth angle;
calculating a preceding length utilizing the seventh angle and the ninth angle;
calculating a third point of time utilizing the length of the third viewing range block and the preceding length; and
driving the first shutter block so that the first shutter block is open at the third point of time.

22. The method of claim 21, wherein the third point of time is later than the first point of time.

23. The method of claim 21, wherein the highest viewpoint of the display unit is lower than the highest viewpoint of the actual viewing range.

24. A display device comprising a display unit and shutter glasses, wherein
the shutter glasses comprise
a shutter lens configured to transmit an image of the display unit, and
a controller configured to control shutoff of the shutter lens,
wherein the shutter lens comprises a first shutter block and a second shutter block,
the controller is configured to:
control shutoff of the first shutter block in response to an image of a first display block of the display unit, and
control shutoff of the second shutter block in response to an image of a second display block of the display unit,
the display unit is configured to alternately display a left eye image and a right eye image,
the shutter lens comprises a left eye shutter lens and a right eye shutter lens, and
the controller is configured to:
control shutoff of the left eye shutter lens in response to the left eye image, and
control shutoff of the right eye shutter lens in response to the right eye image.

25. The display device of claim 24, wherein:
the shutter glasses further comprise a measurement unit configured to measure user location information;
the user location information comprises a distance between a pupil of a user and the display unit, an actual viewing range according to the distance, a first angle from the pupil to a lowest viewpoint of the first display block, a second angle from the pupil to a highest viewpoint of the display unit, and a third angle from the pupil to a highest viewpoint of the actual viewing range; and
the controller is configured to control points of time of the shutoff of the first shutter block and the second shutter block based on the user location information.

26. The display device of claim 25, wherein:
the actual viewing range comprises a first viewing range block; and
the controller is configured to:
calculate a length of the first viewing range block utilizing the first angle and the second angle, and
control the first shutter block utilizing the length of the first viewing range block so that the first shutter block is open at a first point of time.

27. The display device of claim 26, wherein the controller is configured to calculate the length of the first viewing range block utilizing the first angle and the third angle.

28. The display device of claim 26, wherein the lowest viewpoint of the first display block is identical with the highest viewpoint of the display unit.

29. The display device of claim 26, wherein:
the actual viewing range comprises a second viewing range block;
the user location information comprises a fourth angle from the pupil to a lowest viewpoint of the second viewing range block, a fifth angle from the pupil to the highest viewpoint of the display unit, and a sixth angle from the pupil to a highest viewpoint of the second viewing range block; and
the controller is configured to:
calculate a length of the second viewing range block utilizing the fifth angle and the sixth angle,
calculate a delay length utilizing the fourth angle and the fifth angle,
calculate a second point of time utilizing the length of the second viewing range block and the delay length, and
control the first shutter block so that the first shutter block is open at the second point of time.

30. The display device of claim 29, wherein the second point of time is earlier than the first point of time.

31. The display device of claim 29, wherein the highest viewpoint of the display unit is higher than the highest viewpoint of the actual viewing range.

32. The display device of claim 26, wherein:
the actual viewing range comprises a third viewing range block;
the user location information comprises a seventh angle from the pupil to a lowest viewpoint of the third viewing range block, an eighth angle from the pupil to the highest viewpoint of the display unit, and a ninth angle from the pupil to a highest viewpoint of the third viewing range block; and
the controller is configured to:
calculate a length of the third viewing range block utilizing the seventh angle and the eighth angle,
calculate a preceding length utilizing the seventh angle and the ninth angle,
calculate a corresponding third point of time utilizing the length of the third viewing range block and the preceding length, and
control the first shutter block so that the first shutter block is open at the third point of time.

33. The display device of claim 32, wherein the third point of time is later than the first point of time.

34. The display device of claim 32, wherein the highest viewpoint of the display unit is lower than the highest viewpoint of the actual viewing range.
